(19) United States
(12) Patent Application Publication
(10) Pub. No.: US 2008/0060054 A1
(43) Pub. Date: Mar. 6, 2008

(54) METHOD AND SYSTEM FOR DNS-BASED ANTI-PHARMING

(76) Inventor: Manoj Kumar SRIVASTAVA, Reston, VA (US)

Correspondence Address: DLA PIPER US LLP, P. O. BOX 9271, RESTON, VA, 20195, US

(21) Appl. No.: 11/849,478

(22) Filed: Sep. 4, 2007

Related U.S. Application Data
(60) Provisional application No. 60/824,521, filed on Sep. 5, 2006.

(51) Int. Cl. G06F 21/00

(52) U.S. Cl. 726/2

(57) ABSTRACT

A method and system for discovering domain name system (DNS) pharming, comprising: obtaining an answer to a question from two different sources; comparing the answers; determining that the technology is not suspect when the answer is the same; and determining that the technology is suspect when the answer is different.

### CROSS REFERENCE TO RELATED APPLICATIONS

This application claims the benefit of U.S. Provisional Application No. 60/824,521, filed Sep. 5, 2006, and entitled “SYSTEM AND METHOD FOR DNS-BASED ANTI-PHARMING,” which is hereby incorporated by reference in its entirety.

### BRIEF DESCRIPTION OF THE FIGURES

FIG. 1 is a graphical representation of a DNS query resolution.

FIG. 2 identifies points of pharming vulnerabilities in a DNS resolution process.

FIG. 3 illustrates a system for protecting Internet users from getting pharmed, according to one embodiment.

FIG. 4 illustrates a method of protecting Internet users from getting pharmed, according to one embodiment.

FIGS. 5-8 are screen shots that illustrate the system and method for protecting users from getting pharmed, according to one embodiment.

### DESCRIPTION OF EMBODIMENTS OF THE INVENTION

Pharming is a hacker's attack aiming to redirect a Web site's traffic to another (bogus) Web site. Pharming can be conducted either by changing the host file on a victim's computer or by exploitation of a vulnerability in domain name system (DNS) server software. DNS servers are computers responsible for resolving Internet names into their real addresses—they are the “signposts” of the Internet. Compromised DNS servers are sometimes referred to as “poisoned”.

How DNS Works

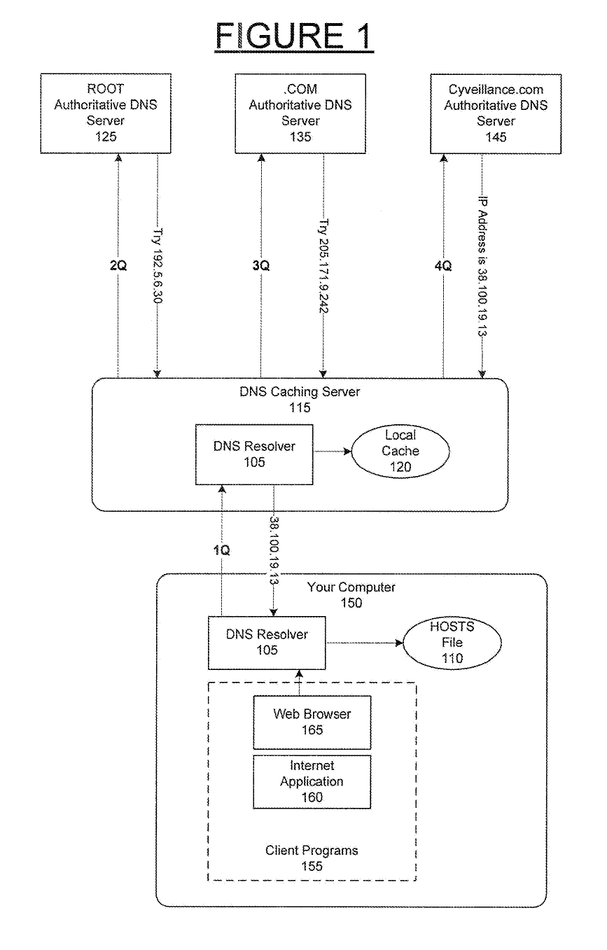

FIG. 1 is a graphical representation of a DNS query resolution. The domain name system (DNS) stores and associates many types of information with domain names, including translating domain names (computer hostnames) to IP addresses. In providing a worldwide keyword-based redirection service, DNS is a component of contemporary Internet use.

Useful for several reasons, DNS makes it possible to attach easy-to-remember hostnames (such as “cyveillance.com”) to hard-to-remember IP addresses (such as 38.100.19.13). Humans take advantage of this when they recite URLs and e-mail addresses instead of IP addresses.

Users generally don't communicate directly with a DNS server. Instead DNS resolution takes place transparently in client applications such as Web browsers, email clients and other Internet applications. Referring to FIG. 1, a computer 150 has several client programs 155, including Web browser 165 and/or Internet Application 160. When a request is made which necessitates a DNS lookup, such programs send a resolution request to local DNS resolver 105, which handles the communications required to resolve a hostname to an IP address.

The local DNS resolver 105 first looks up the IP address in a hosts file 110 (i.e., a file in most operating systems which has a mapping between Web addresses (such as example.com) and the corresponding IP addresses (such as 192.0.34.166)) to find the hostname to IP address mapping. If the answer is not found in the hosts file 110, the local DNS resolver sends the resolution, request to a designated DNS caching server 115. For most home users the DNS caching server 115 is hosted by their ISP. Some businesses also use DNS caching servers 115 hosted by their ISPs. Others host and administer their own DNS caching servers 115.

The DNS caching server 115 looks in its local cache 120 to see if it has the answer for the resolution request. For performance, scalability, and other reasons, DNS caching servers cache the answer of recent DNS queries in the local cache 120. If the answer is not found in the local cache 120, the DNS caching server queries an authoritative DNS server 145, which is authoritative for a certain domain. This information is obtained by the DNS caching server 115 by traversing the DNS hierarchy for that domain starting at the root DNS server. For example; to resolve www.cyveillance.com, the DNS caching server will query the authoritative DNS server 135 for the root. If the root authoritative DNS server 125 does not know the IP address for www.cyveillance.com, it will tell the DNS caching server 115 who to query to find this answer. In this example, the root authoritative DNS server 125 indicates that IP address 192.5.6.30 may know the IP address for cyveillance.com. The DNS caching server 115 can then query IP address 192.5.6.30, which is the .com authoritative DNS server 145 to resolve cyveillance.com. If the .com authoritative DNS server 135 does not know the requested IP address for cyveillance.com, it can indicate that IP address 205.171.9.242 may know the IP address for www.cyveillance.com. The DNS caching server 115 will then query IP address 205.17.1.9.242, the www.cyveillance.com authoritative DNS server 145, which knows that the IP address of the host www.cyveillance.com, is 38.100.19.13. Subsequent queries for this hostname to the DNS caching server 115 will be immediately resolved by the cached answer in the local cache 120 until the cached answer expires, as determined by time-to-live (TTL) attribute of the cyveillance.com domain set by the DNS administrator of that domain.

How Pharming Attacks are Carried Out

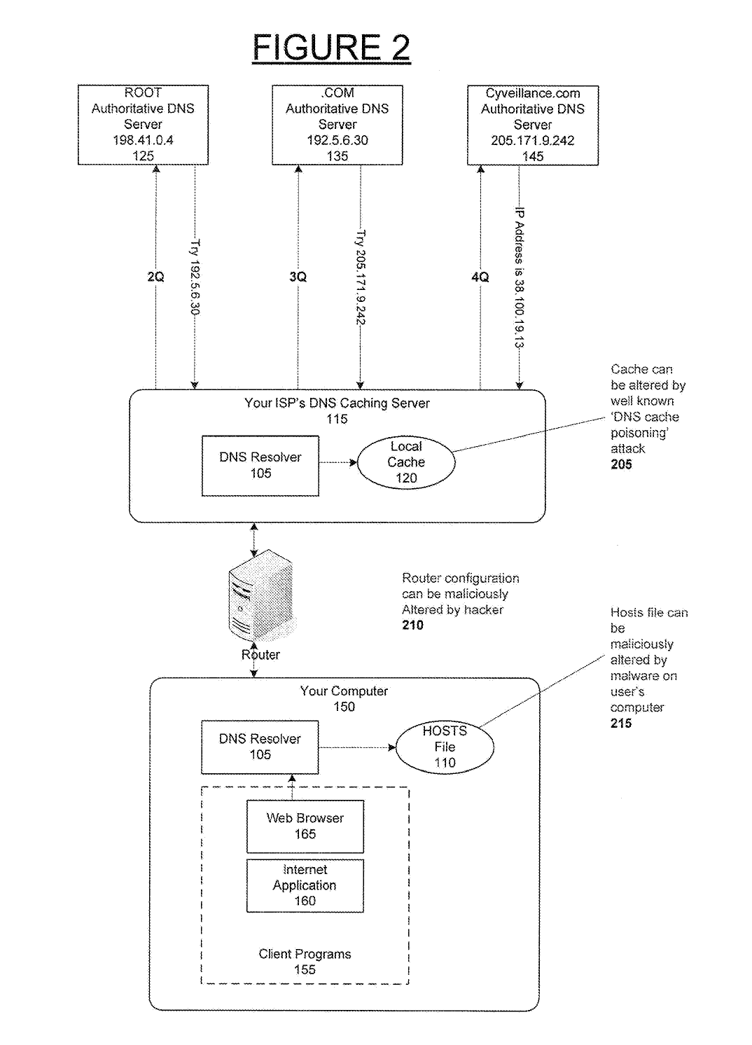

FIG. 2 identifies points of pharming vulnerabilities in a DNS resolution process. FIG. 2 illustrates the system of FIG. 1, but identifies vulnerability points 205, 210, and 215. Suppose a criminal wants to steal someone's personal sensitive information. He sets up a fake Web site that resembles the look and feel of a bank or other online Web site. He can induce victims to visit the Web site and divulge their sensitive information such as credit card number, expiration date, account login and password, bank account number etc. Phishing is a common tactic, but it can be defeated if the victim notices the Web address doesn't match. However if the criminal hijacks the victims DNS resolution process and effectively replaces the IP address of the target Web site from it's real IP address to the IP address of the fake Web site, the victim can enter the correct Web address and yet get directed to the fake Web site. Personal computers are easy targets for pharming attacks because they receive poorer administration than most business Internet servers. However, business Internet servers can also be targets.

Malicious domain name resolution can result from compromises in large numbers of trusted nodes that participate in name resolution. As shown by 215, incorrect entries in the victim's computer's hosts file 110, which circumvents DNS name resolution with its own local name to IP address mapping, is a popular target for malware (malicious software).

As shown by 210, compromise of a local network router 220 can also induce pharming attacks. Since most routers 220 specify a trusted DNS caching server to clients as they join the network, misinformation here will spoil hostname lookups for the entire Local Area Network (LAN). Unlike host file rewrites, local router compromise is difficult to detect. Nearly every router 220 allows its administrator to specify a particular trusted DNS caching server in place of the one suggested by an upstream node (e.g., the ISP). An attacker could specify the DNS server under his control. All subsequent hostname resolutions will go through the bad server. Alternatively, many routers have the ability to replace their firmware. Like malware on the desktop systems, a firmware replacement can be very difficult to detect. The ubiquity of consumer grade wireless routers presents a massive vulnerability. Administrative access is available wirelessly on most of these devices. Moreover, since these routers often work with their default settings, administrative passwords are commonly unchanged. Even when altered, many are guessed quickly through dictionary attacks, since most consumer grade routers don't introduce timing penalties for incorrect login attempts.

As shown by 205, pharming attacks can also be propagated via DNS cache poisoning. This is a technique that tricks a DNS caching server 115 into believing it has received authentic information as part of a hostname resolution request issued by it when, in reality, it has not. Once the DNS caching server 115 has been poisoned, the information is generally cached for a while, spreading the effect of the attack to other users of the DNS caching server.

Normally, an Internet-connected computer uses a DNS caching server 115 provided by the computer owner's Internet Service Provider (ISP). This DNS caching server 115 generally serves the ISP's own customers only and contains DNS information cached by previous users of the server. A poisoning attack on a single ISP DNS caching server 115 can affect the users serviced directly by the compromised DNS caching server 115.

System and Method for Anti-Pharming

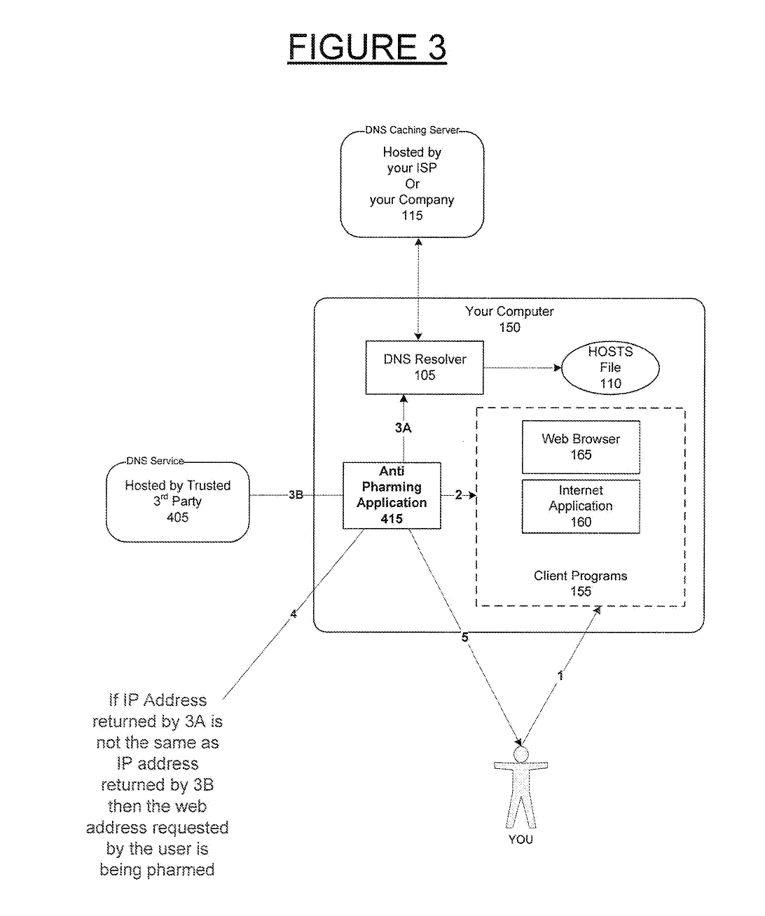

FIG. 3 illustrates a system for protecting Internet users from getting pharmed, according to one embodiment. The computer 150, DNS resolver 105, hosts file 110, and client programs 155 (e.g., Web browser 165, Internet application 160) are as described in FIG. 1. An anti-pharming application (APA) 415 has been added to protect Internet users that use the computer 150 from getting pharmed. The system utilizes the APA 415 to query the user's DNS caching service 115 (as described in FIG. 1), and a 3^{rd} party DNS service 405 to ascertain if the Web site that an Internet user wants to go to is being pharmed.

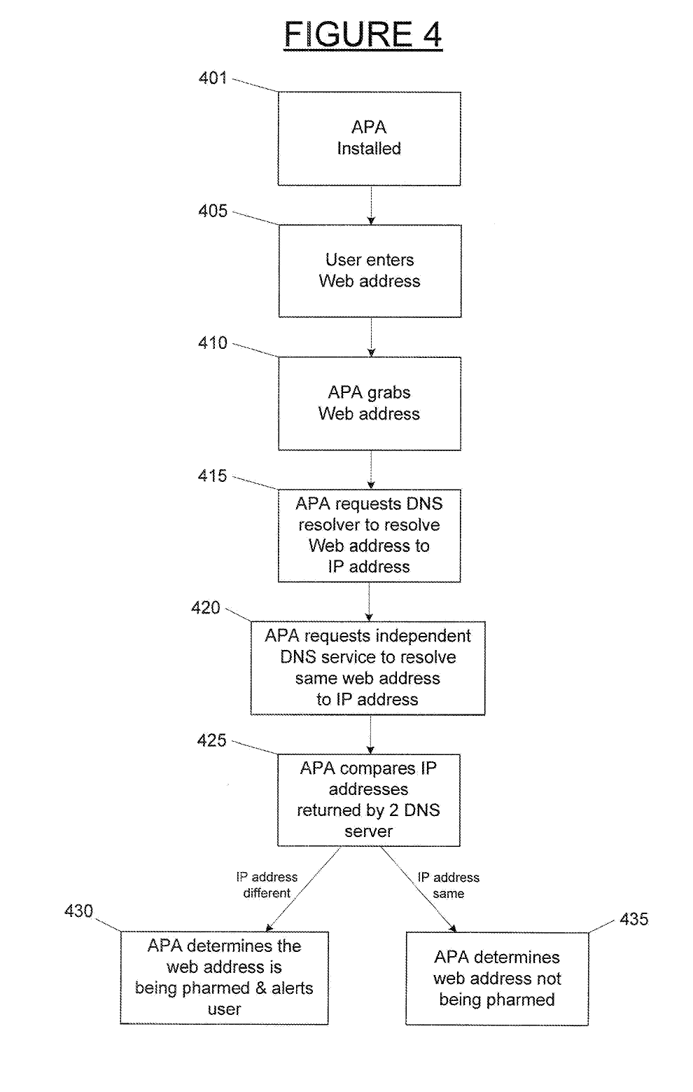

FIG. 4 illustrates a method of protecting Internet users from getting pharmed, according to one embodiment. In 401, a browser-plug in, browser helper object, browser tool bar or a client side application is installed on the internet user's computer as anti-pharming application 415. Those of ordinary skill in the art will see that other objects may be utilized. In this example, these types of objects will also be referred to as an anti-pharming application (APA) 415. In 405, a user enters a Web address in an Internet application. In 410, the APA 415 grabs that Web address from the Internet application. In 415, the APA 415 requests the DNS resolver 105 on the user's computer to resolve that Web address to an IP address. In 420, the APA 415 also requests an independent and trusted third party DNS service to resolve the same Web address to an IP address. In doing so, the APA 415 ensures that it does not query the hosts file 110 on the user's computer or the DNS caching server 115 preconfigured for use by the user's computer. This way, the APA 415 obtains answers to the Web address resolution to an IP address through two completely independent DNS resolution processes and infrastructures. In 425, the APA 415 compares the IP addresses returned by the two independent DNS resolution processes. In 430, if the IP addresses are different, the APA 415 determines that the Web address is being pharmed, and alerts the user. In 435, if the IP addresses are the same, the APA 415 determines that the Web address is not being pharmed.

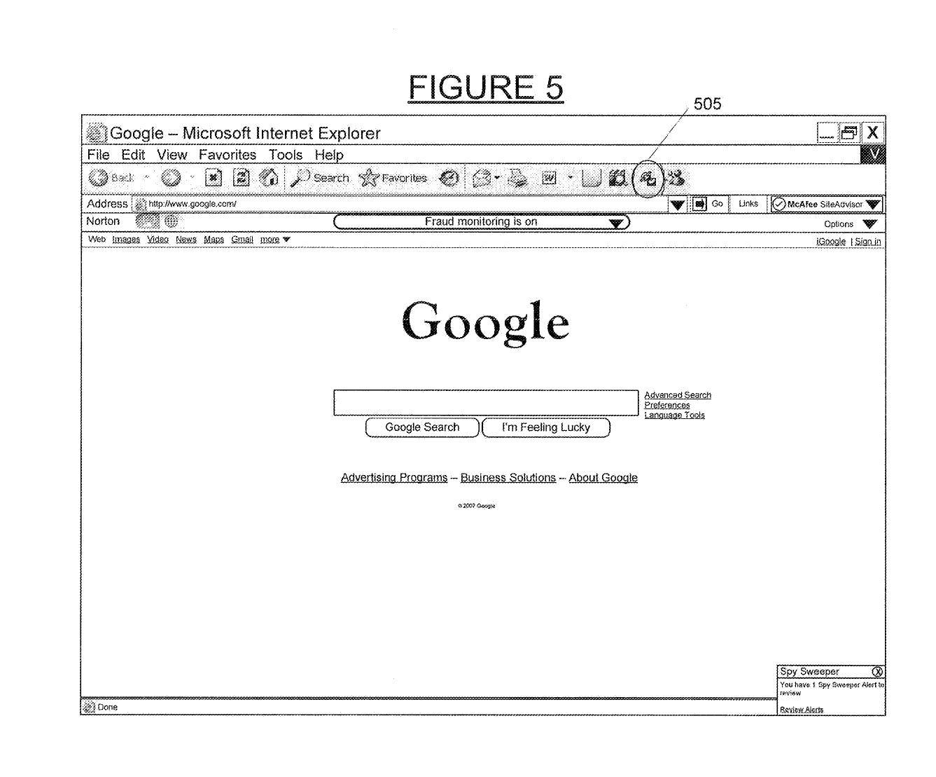

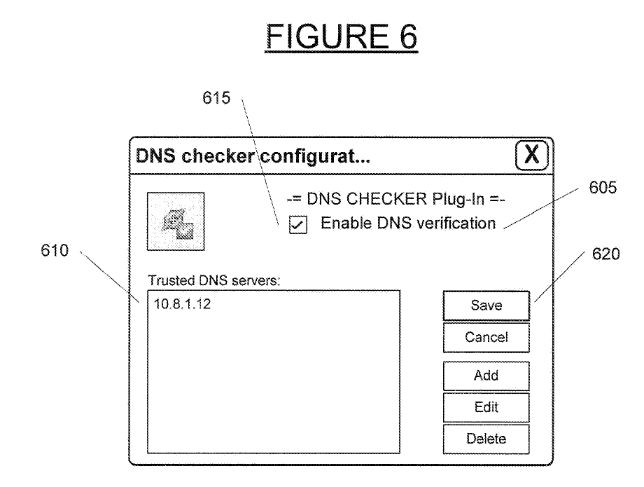

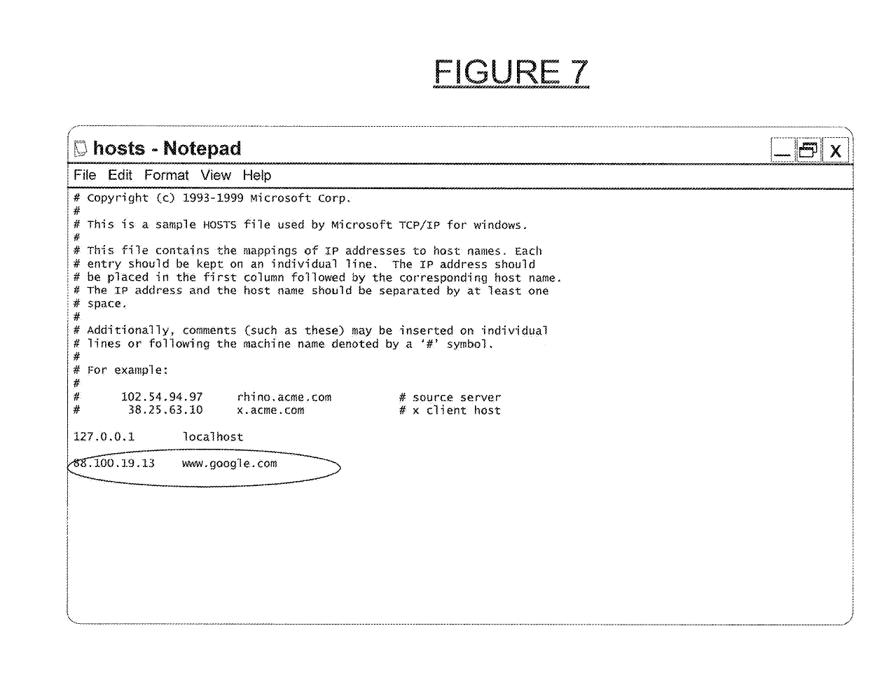

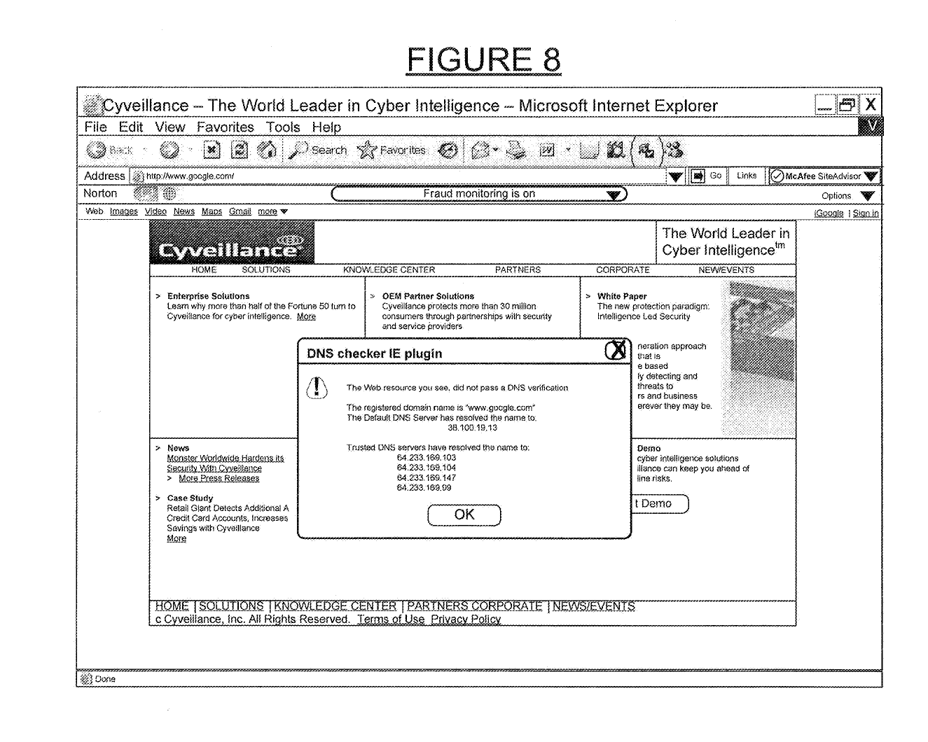

FIGS. 5-8 are screen shots that illustrate the system and method for protecting users from getting pharmed, according to one embodiment. FIG. 5 illustrates an Internet Explorer (IE) plug-in 505 (also referred to as the DNSChecker icon). Once the IE plug-in is installed the user can double click on the DNSChecker icon 505 to enable the plug-in for alerting pharming attacks. FIG. 6 illustrates a screen shot where the user is able to enable the plug-in for alerting pharming attacks 605 by checking the box 615 and utilizing the save feature 620. The user may also choose to specify their own trusted DNS service(s) 610. FIG. 7 is an example of host file information found when the DNS resolver 105 checks the host file 110. FIG. 8 illustrates an example of an error message shown when a user desires to go to www.google.com, and is instead directed to a Web site hosted at 38.100.19.13, which happens to be www.cyveillance.com. If the APA plug-in 505 is installed, it will warn the user of this pharming attack, as shown in the screen shot of FIG. 8.

### CONCLUSION

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C.112, paragraph 6. Claims that do not expressly include the phrase “means for” or “step for” are not to be interpreted under 35 U.S.C.112, paragraph 6.

1. A method of discovering domain name system (DNS) pharming, comprising:
obtaining a Web address from a user's computer in an Internet application;
requesting a DNS resolver on the user's computer and/or the network to which the computer is connected to resolve the Web address to an IP address;
requesting a third-party DNS server to resolve the same Web address to an IP address;
comparing the IP addresses returned by the DNS resolver and the IP address returned by the third-party DNS server; and
determining the Web address is being pharmed when the compared IP addresses are different.

2. The method of claim 1, further comprising alerting the user the Web address is being pharmed.

3. The method of claim 1, further comprising:
determining that the Web address is not being pharmed when the compared IP addresses are the same.

4. A method for discovering domain name system (DNS) pharming, comprising:
obtaining an answer to a question from two different sources;
comparing the answers;
determining that the technology is not suspect when the answer is the same; and
determining that the technology is suspect when the answer is different.

5. The method of claim 4, wherein the question is “What IP address corresponds to a Web address?”

6. The method of claim 5, wherein the answer is the IP address that corresponds to the Web address.

7. The method of claim 6, wherein the two different sources are a) a DNS resolver on a user's computer and/or the network to which the computer is connected and b) a third-party DNS server.

8. A system for discovering domain name system (DNS) pharming, comprising:
a server coupled to a network;
a database accessible by the server; and
an application coupled to the server, the application configured for:
obtaining a Web address from a user's computer in an Internet application;
requesting a DNS resolver on the user's computer and/or the network to which the computer is connected to resolve the Web address to an IP address;
requesting a third-party DNS server to resolve the same Web address to an IP address;
comparing the IP addresses returned by the DNS resolver and the IP address returned by the third-party DNS server; and
determining the Web address is being pharmed when the compared IP addresses are different.

9. The system of claim 8, wherein the application further comprises:
alerting the user the Web address is being pharmed.

10. The system of claim 8, wherein the application further comprises:
determining that the Web address is not being pharmed when the compared IP addresses are the same.

11. A system for discovering domain name system (DNS) pharming, comprising:
a server coupled to a network;
a database accessible by the server; and
an application coupled to the server, the application configured for:
obtaining an answer to a question from two different sources;
comparing the answers;
determining that the technology is not suspect when the answer is the same; and
determining that the technology is suspect when the answer is different.

12. The system of claim 11, wherein the question is “What IP address corresponds to a Web address?”

13. The system of claim 12, wherein the answer is the IP address that corresponds to the Web address.

14. The system of claim 13, wherein the two different sources are a) a DNS resolver on a user's computer and/or the network to which the computer is connected and b) a third-party DNS server.
